(19) United States
(12) Patent Application Publication
(10) Pub. No.: US 2015/0138822 A1
(43) Pub. Date: May 21, 2015

(54) AUTOMOTIVE LAMP

(71) Applicant: Koito Manufacturing Co., Ltd., Minato-ku (JP)

(72) Inventor: Masashi TATSUKAWA, Shizuoka-shi (JP)

(21) Appl. No.: 14/560,549

(22) Filed: Dec. 4, 2014

Related U.S. Application Data
(63) Continuation of application No. PCT/JP2013/003244, filed on May 21, 2013.

(30) Foreign Application Priority Data
Jun. 5, 2012 (JP) 2012-128294

(51) Int. Cl. F21S 8/10

(52) U.S. Cl. CPC F21S 48/125; F21S 48/1317; F21S 48/115; F21W 2101/10
USPC 362/516

(57) ABSTRACT

A first lamp unit includes a first light-emitting device, a reflector substantially having a form of an ellipse having a focal point located at the first light-emitting device or the neighborhood thereof, and a first partial lens located in front of the reflector. A second lamp unit adjacent to the first lamp unit includes a second light-emitting device, and a second partial lens located in front of the second light-emitting device and joined to the first partial lens. The first partial lens has a form produced by cutting the side toward the second partial lens with a substantially vertical plane, and the second partial lens has a form produced by extending the plane of section of the first partial lens along a predetermined line.

### BACKGROUND OF THE INVENTION

1. Field of the Invention

The present invention relates to an automotive lamp in which an aspherical projection lens is used.

2. Description of the Related Art

Recently, development of automotive headlamps in which semiconductor light-emitting devices such as light-emitting diodes are used has been promoted. Patent document 1 discloses an automotive headlamp configured to reflect light from three light-emitting devices forward, using three reflectors. A single cylindrical lens extending in the direction of vehicle width is located as a projection lens in front of the three reflectors. According to the disclosure, a light distribution pattern of a substantially constant form can be formed even when the position of the cylindrical lens or the position of the reflector is shifted more or less in the direction of vehicle width, with the result that the lamp structure is simplified.

[patent document 1] JP2005-294176

In the technology disclosed in patent document 1, a cylindrical lens having a uniform cross section in the direction of vehicle width is used so that the automotive lamp is capable of forming only limited light distribution patterns.

### SUMMARY OF THE INVENTION

In this background, a purpose of the embodiments of the present invention is to provide a technology capable of forming a variety of light distribution patterns in an automotive lamp provided with a plurality of lamp units having a light-emitting device and a reflector and with an integrated projection lens.

The automotive lamp according to an embodiment of the present invention includes a first lamp unit and a second lamp unit. The first lamp unit includes a first light-emitting device, a reflector substantially having a form of an ellipse having a focal point located at the first light-emitting device or the neighborhood thereof, and a first lens located in front of the reflector. The second lamp unit is adjacent to the first lamp unit and includes a second light-emitting device and a second lens located in front of the second light-emitting device and joined to the first lens. The first lens has a form produced by cutting the side toward the second lens by a substantially vertical plane, and the second lens has a form produced by extending the plane of section of the first lens along a predetermined line.

According to this embodiment, the form of the second lens produced by extending the plane of section of the first lens along a predetermined line can be changed depending on where the first lens is cut so that a variation of light distribution patterns that can be formed by the second lens is increased.

The automotive lamp according to an embodiment of the present invention includes a first lamp unit and a second lamp unit. The first lamp unit includes a first light-emitting device, a reflector substantially having a form of an ellipse having a focal point located at the first light-emitting device or the neighborhood thereof, and a first lens located in front of the reflector. The second lamp unit is adjacent to the first lamp unit and includes a second light-emitting device and a second lens located in front of the second light-emitting device and joined to the first lens. The second lens is formed to have a vertical cross section extending uniformly along a predetermined line. The first and second lenses are located such that the focal point of the first lens and the focal point of the second lens are located on the same plane.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic perspective of an automotive lamp according to an embodiment of the present invention;

FIG. 2 is a schematic cross sectional view obtained by observing the plane of section by the vertical plane including a light axis Ax of FIG. 1 in a direction indicated by arrow D of FIG. 1;

FIGS. 3A and 3B show the form of a projection lens of integrated type in detail;

FIG. 4 shows an exemplary light distribution pattern formed by the automotive lamp; and

FIGS. 5A-5D show a projection lens of integrated type according to another embodiment of the present invention.

### DETAILED DESCRIPTION OF THE INVENTION

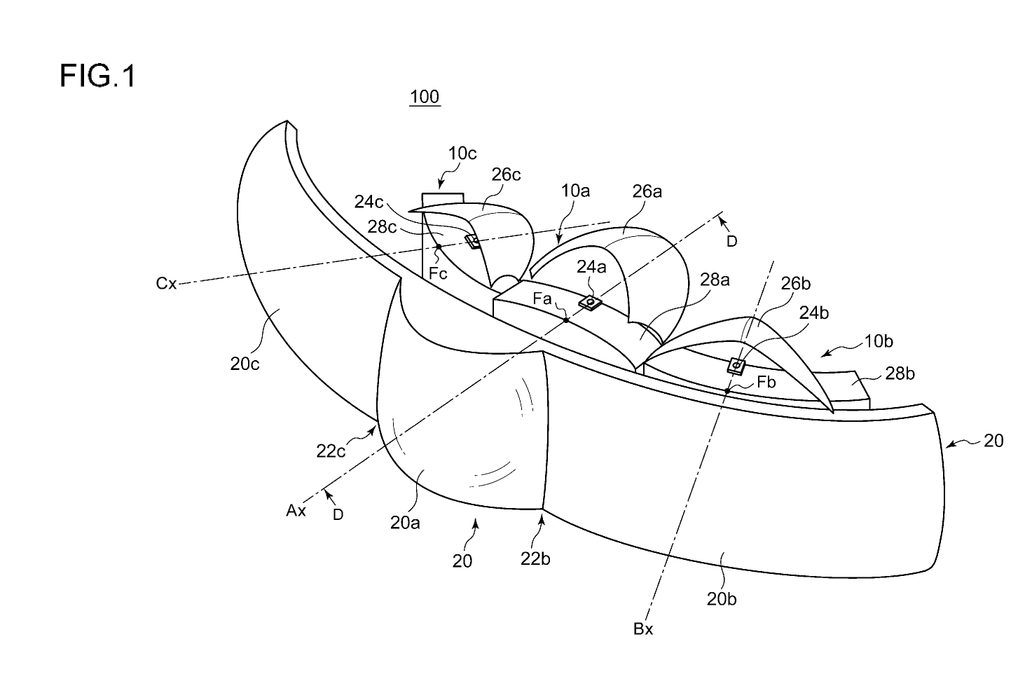

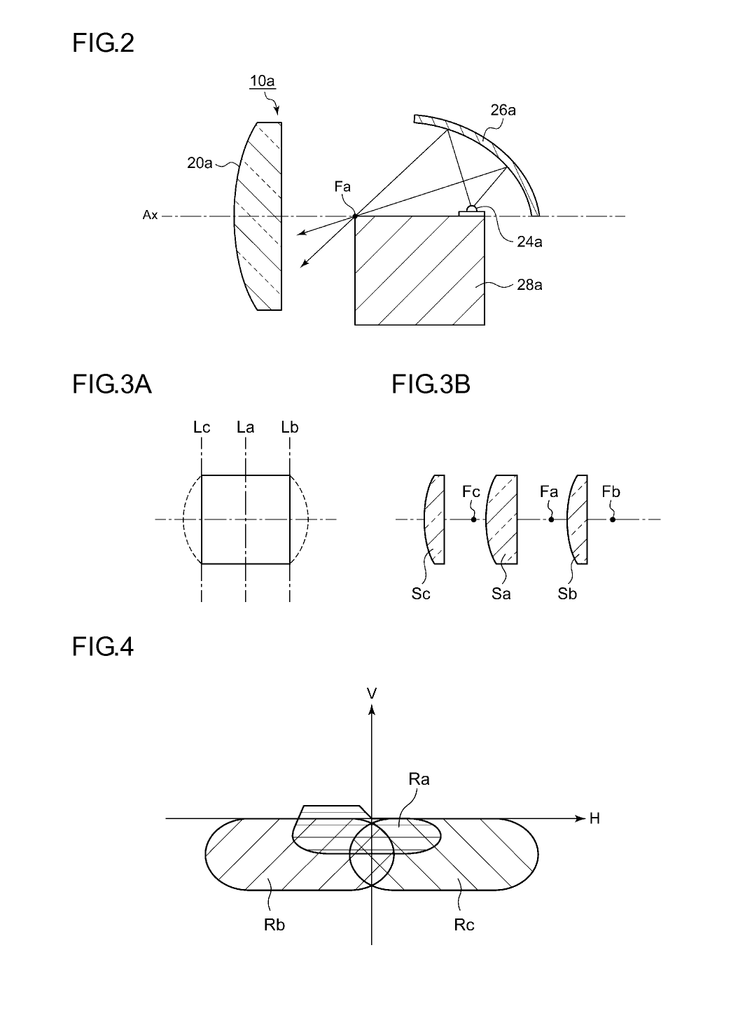

A description will now be given of an automotive lamp 100 according to an embodiment of the present invention with reference to FIGS. 1 and 2. The automotive lamp 100 is provided in the frontal part of a vehicle such that, for example, the horizontal direction of FIG. 1 is aligned with the direction of vehicle width.

FIG. 1 is a schematic perspective view of the automotive lamp 100. The automotive lamp 100 includes three lamp units 10a, 10b, and 10c. The lamp units 10a, 10b, and 10c are lamps of projection type having respective light axes Ax, Bx, and Cx and include light-emitting devices 24a, 24b, and 24c and reflectors 26a, 26b, and 26c, respectively.

In contrast, a projection lens 20 located in front of the reflectors 26a, 26b, and 26c have an integrated structure. The projection lens 20 is configured to provide different light distribution properties across flexures 22b and 22c of FIG. 1. Details will be described later. The section sandwiched by the flexures 22b and 22c will be referred to as a partial lens 20a, the section to the right of the flexure 22b as a partial lens 20b, and the section to the left of flexure 22c as a partial lens 20c. As can be seen in FIG. 1, the partial lens 20a functions as a part of the lamp unit 10a, the partial lens 20b functions as a part of the lamp unit 10b, and the partial lens 20c functions as a part of the lamp unit 10c.

FIG. 2 is a schematic cross sectional view obtained by observing the plane of section by the vertical plane including a light axis Ax shown in FIG. 1 in a direction indicated by arrow D of FIG. 1.

The reflector 26a has a reflective surface that is substantially elliptically curved such that the light axis Ax extending in the longitudinal direction of the vehicle defines the central axis, the reflective surface facing the light-emitting device 24a. The reflective surface is configured such that the cross section including the light axis Ax is elliptical and the eccentricity of the ellipse gradually grows from the vertical cross section toward the horizontal cross section.

The light-emitting device 24a (e.g., LED) as a light source is located at the first focal point of the ellipse located on the light axis Ax and forming the vertical cross section of the reflective surface of the reflector 26a. For this reason, the light emitted from the light-emitting device a is converged at the second focal point (denoted by Fa in FIGS. 1 and 2).

The partial lens 20a is a plano-convex aspherical lens, the front surface thereof being convex and the rear surface thereof being planar. The partial lens 20a is located such that the back focal point is substantially aligned with the second focal point Fa of the reflective surface of the reflector 26a and projects an image on the back focal plane onto a virtual vertical screen located in front of the lamp as an inverted image.

A shaper 28a on which the light-emitting device 24a is provided extends to the neighborhood of the second focal point Fa and plays the role of a shade forming a horizontal cutoff line on the virtual vertical screen.

In the lamp unit 10a, the light emitted by the light-emitting device 24a is reflected by the reflective surface of the reflector 26a, the light is partly shielded by the shaper 28a in the neighborhood of the focal point Fa, and a light distribution pattern having a cutoff line is formed on the virtual vertical screen via the partial lens 20a.

The lamp units 10b and 10c are configured similarly as the lamp unit 10a (not shown). In other words, the light emitted by the light-emitting device 24b of the lamp unit 10b is reflected by the reflective surface of the reflector 26b so that a light distribution pattern having a cutoff line is formed on the virtual vertical screen via the partial lens 20b. Similarly, the light emitted by the light-emitting device 24c of the lamp unit 10c is reflected by the reflective surface of the reflector 26c so that a light distribution pattern having a cutoff line is formed on the virtual vertical screen via the partial lens 20bc. However, the lamp units 10b and 10c differ from the lamp unit 10a in that the ellipse forming the vertical cross section of the reflective surface of the reflectors 26b and 26c is extended in the direction of vehicle width. For this reason, the reflectors 26b and 26c do not converge the light from the light-emitting devices 24a and 24b at the focal points Fb and Fc (see FIG. 1), respectively, in the direction of vehicle width.

FIGS. 3A and 3B show the form of the projection lens 20 of integrated type in detail. FIG. 3A is a front view of the plano-convex aspherical sphere. The left and right ends of the plano-convex lens are cut by vertical planes Lb and Lc to obtain the partial lens 20a. Only a small amount of reflected light from the reflector reaches areas of the aspherical lens marked by the dotted lines in the figure so that the amount of light beam remains largely unaffected even if these areas are cut.

FIG. 3B shows cross sections produced by cutting the plano-convex aspherical lens by vertical planes La, Lb, and Lc. The partial lenses 20b and 20c have a three-dimensional form swept when the left and right planes of sections Sb and Sc of the aspherical lens are swept along a predetermined line. The predetermined line is a curve according to the embodiment but may be a straight line.

If the predetermined line is a curve, the partial lenses 20b and 20c will be toric lenses. Therefore, the partial lenses 20b and 20c diffuse light only in the horizontal direction. Thus, the partial lens 20a and the pair of partial lenses 20b and 20c have different cross sections so that they provide different light distributing functions. If the predetermined line is a straight line, the partial lenses 20b and 20c will be cylindrical lenses.

By selecting a predetermined line located on the same plane as the light axis of the aspherical lens, the focal point of the partial lens 20a and the focal points of the partial lenses 20b and 20c will be located on the same plane.

Desirably, the projection lens is integrally formed by, for example, injection molding. However, the projection lens may be formed by separately molding the partial lenses 20a, 20b, and 20c and adhering the partial lenses at the flexures 22b and 22c shown in FIG. 1.

FIG. 4 shows an exemplary light distribution pattern formed by the automotive lamp 100. Referring to FIG. 4, a light distribution pattern Ra is formed by the lamp unit 10a, a light distribution pattern Rb is formed by the lamp unit 10b, and a light distribution pattern Rc is formed by the lamp unit 10c.

In this example, the three lamp units form a low beam light distribution pattern so that an area immediately below the horizon H is most brightly illuminated. As in this example, three lamp units may form a single light distribution (e.g., a low beam or a high beam) or the lamp units may form different light distributions. In the latter case, the forms of the partial lenses 20a, 20b, and 20c may be designed such that the lamp unit 10a functions as a high beam on its own, and the lamp units 10b and 10c function as a low beam, a clearance lamp, a cornering lamp, or a daytime running lamp.

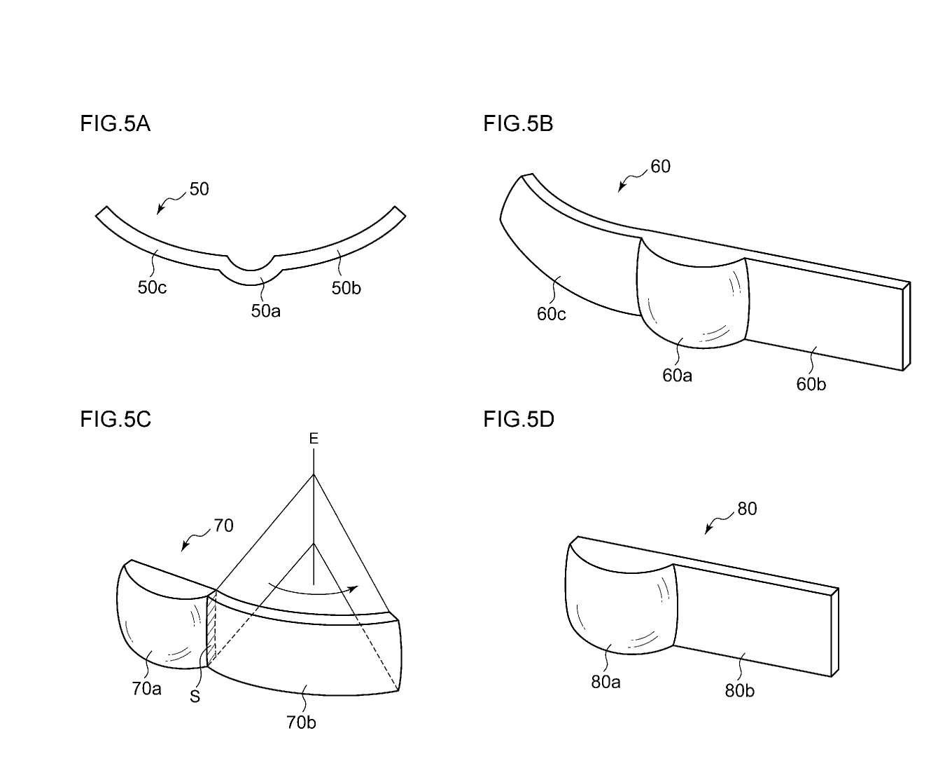

FIGS. 5A-5D are alternative examples of the projection lens of integrated type. FIG. 5A shows a projection lens 50 in which a partial lens 50a at the center is not a plano-convex aspherical lens, unlike the projection lens 20 shown in FIG. 1. The surface of the partial lens 50a toward the light-emitting device is configured to be concave. The partial lens 50a may be a biconvex lens. FIG. 5B shows a projection lens 60 in which a partial lens 60b to the right of a partial lens 60a is caused to extend along a straight line.

FIGS. 5C and 5D show projections lenses 70 and 80 including two partial lenses. The projection lens 70 of FIG. 5C is formed such that a partial lens 70b to the right of a partial lens 70a extends along a curve. In contrast, a projection lens 80 of FIG. 5D is formed such that a partial lens 80b to the right of a partial lens 80a extends along a straight line. When the partial lens is configured to have a curved form as shown in FIG. 5C, the partial lens 70b may have a form produced by rotating the cross section S of the partial lens 70a around a vertical line E.

As described above, an automotive lamp in which a plurality of lamp units each having a light source and a reflector are arranged side by side may be configured such that the projection lenses are integrated. Because there is no need to support the projection lenses individually, the structure for holding the lens can be simplified and the volume occupied by the support structure in the lamp chamber can be reduced. An installation error may be induced between lenses if the projection lenses are separately formed. By integrating the projection lenses, such error is eliminated.

The form of the partial lenses extending left and right from the section of plane can be changed depending on where the source aspherical lens is cut, resulting in rich variation of light distribution patterns formed by the partial lenses.

The embodiments of the present invention are not limited to those described above and various modifications such as design changes may be made based on the knowledge of a skilled person. The structures shown in the drawings are for illustrative purposes. The structures may be modified as appropriate so long as the same function is achieved. The structures modified as such would provide the same advantage.

The embodiments described above may be combined for use in an arbitrarily manner so long as the embodiments are not incompatible with each other.

The cylindrical lens (or the toric lens) extending to the left or right of the plano-convex aspherical lens is described as having a uniform vertical cross section. Alternatively, the lenses may be formed such that the cross-sectional area is slightly decreased toward the left end or the right end of the vehicle.

The lamp units of the embodiments are described as being configured such that the light emitted by the light-emitting device is reflected by the reflector. However, some or all of the lamp units may be of direct incidence type, namely, the lamp units may be configured such that the light-emitting device is located in the neighborhood of the back focal point of the projection lens so as to allow light emitted by the light-emitting device to be directly incident on the projection lens.

1. An automotive lamp comprising:
a first lamp unit; and
a second lamp unit,
the first lamp unit including:
a first light-emitting device;
a reflector substantially having a form of an ellipse having a focal point located at the first light-emitting device or the neighborhood thereof; and
a first lens located in front of the reflector, and the second lamp unit being adjacent to the first lamp unit and including:
a second light-emitting device; and
a second lens located in front of the second light-emitting device and joined to the first lens, wherein
the first lens has a form produced by cutting the side toward the second lens by a substantially vertical plane,
the second lens has a form produced by extending the plane of section of the first lens along a predetermined line, and
the first and second lenses provide different light distribution properties.

2. An automotive lamp comprising:
a first lamp unit; and
a second lamp unit,
the first lamp unit including:
a first light-emitting device;
a reflector substantially having a form of an ellipse having a focal point located at the first light-emitting device or the neighborhood thereof; and
a first lens located in front of the reflector, and
the second lamp unit being adjacent to the first lamp unit and including:
a second light-emitting device; and
a second lens located in front of the second light-emitting device and joined to the first lens, wherein
the second lens is formed to have a vertical cross section extending uniformly along a predetermined line,
the first and second lenses are located such that a focal point of the first lens and a focal point of the second lens are located on the same plane, and
the first and second lenses provide different light distribution properties.

3. The automotive lamp according to claim 1, wherein the predetermined line is a curve.

4. The automotive lamp according to claim 1, wherein the second lamp unit is configured such that light emitted by the second light-emitting device is directly incident on the second lens.

5. The automotive lamp according to claim 1, wherein the second lamp unit includes a reflector of a form produced by horizontally extending a substantially elliptical vertical cross section.

6. The automotive lamp according to claim 1, wherein the first and second lenses are designed such that the first lamp unit forms a high beam and the second lamp unit forms a low beam.
